(19) United States
(12) Patent Application Publication
(10) Pub. No.: US 2023/0412482 A1
(43) Pub. Date: Dec. 21, 2023

(54) VEHICLE-MOUNTED DEVICE, MANAGEMENT DEVICE, ANOMALY DETERMINATION METHOD, AND ANOMALY DETERMINATION PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Masashi WATANABE, Yokkaichi-shi, Mie (JP)

(21) Appl. No.: 18/252,214

(22) PCT Filed: Oct. 26, 2021
(86) PCT No.: PCT/JP2021/039476

§ 371 Date: May 9, 2023

(30) Foreign Application Priority Data
Nov. 11, 2020 (JP) 2020-188256

(51) Int. Cl. H04L 43/0852; H04L 43/0882; H04L 67/12; H04L 41/06

(52) U.S. Cl. CPC H04L 43/0852; H04L 43/0882; H04L 67/12; H04L 41/06

(57) ABSTRACT

Provided is a vehicle-mounted device that can be mounted in a vehicle, including: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit.

### CROSS-REFERENCE TO RELATED APPLICATIONS

This application is the U.S. national stage of PCT/JP2021/039476 filed on Oct. 26, 2021, which claims priority of Japanese Patent Application No. JP 2020-188256 filed on Nov. 11, 2020, the contents of which are incorporated herein.

### TECHNICAL FIELD

The present disclosure relates to a vehicle-mounted device, a management device, an anomaly determination method, and an anomaly determination program.

### BACKGROUND

JP 2013-168865A discloses the following vehicle-mounted network system. That is to say, the vehicle-mounted network system includes: a vehicle-mounted control device including a memory configured to store definition data defining a portion dependent on implementation on the vehicle-mounted network among the communication protocols used on the vehicle-mounted network; and a communication protocol issuing device configured to issue the definition data to the vehicle-mounted control device. Upon receiving a registration request requesting to allow the vehicle-mounted control device to join the vehicle-mounted network from a registration device configured to allow the vehicle-mounted control device to join the vehicle-mounted network, the communication protocol issuing device authenticates the registration device and then generates the definition data in compliance with the implementation on the vehicle-mounted network, and sends it to the registration device. The registration device receives the definition data sent by the communication protocol issuing device and requests the vehicle-mounted control device to store the received definition data in the memory. The vehicle-mounted control device then receives the definition data from the registration device, stores it in the memory, and performs communication using the vehicle-mounted network in compliance with the communication protocols in accordance with the part defined by the definition data.

Conventionally, techniques related to a vehicle-mounted network including a plurality of vehicle-mounted devices have been developed.

In the vehicle-mounted network described in JP 2013-168865A, data is transmitted and received between a plurality of vehicle-mounted devices. However, if an anomaly occurs in a transmission line of data between the vehicle-mounted devices, communication between these vehicle-mounted devices is not performed properly, which may cause issues such as the inability to control the vehicle properly.

The present disclosure was made in order to address the above-described issues, and it is an object of the disclosure thereof to provide a vehicle-mounted device, a management device, an anomaly determination method, and an anomaly determination program that make it possible to detect a failure in a vehicle in advance.

### SUMMARY

The present disclosure is directed to a vehicle-mounted device that can be mounted in a vehicle, including: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit.

The present disclosure is directed to a management device including: an acquisition unit configured to acquire positional information regarding a vehicle of interest in which a propagation delay time of data between vehicle-mounted devices mounted in the vehicle of interest satisfies a predetermined condition; and a determination unit configured to perform anomaly determination on a transmission line of the data in the vehicle of interest, based on the positional information regarding the vehicle of interest acquired by the acquisition unit and other information.

The present disclosure is directed to an anomaly determination method for use by a vehicle-mounted device mounted in a vehicle, including: a step of measuring a propagation delay time of data between the vehicle-mounted device and another vehicle-mounted device mounted in the vehicle; and a step of performing anomaly determination on a transmission line of the data, based on the measured propagation delay time.

The present disclosure is directed to an anomaly determination method for use by a management device, including: a step of acquiring positional information regarding a vehicle of interest in which a propagation delay time of data between vehicle-mounted devices mounted in the vehicle of interest satisfies a predetermined condition; and a step of performing anomaly determination on a transmission line of the data in the vehicle of interest, based on the acquired positional information regarding the vehicle of interest and other information.

The present disclosure is directed to an anomaly determination program for use by a vehicle-mounted device mounted in a vehicle, for causing a computer to function as: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit.

The present disclosure is directed to an anomaly determination program for use by a management device, for causing a computer to function as: an acquisition unit configured to acquire positional information regarding a vehicle of interest in which a propagation delay time of data between vehicle-mounted devices mounted in the vehicle of interest satisfies a predetermined condition; and a determination unit configured to perform anomaly determination on a transmission line of the data in the vehicle of interest, based on the positional information regarding the vehicle of interest acquired by the acquisition unit and other information.

An aspect of the present disclosure can not only be realized as a vehicle-mounted device that includes these characteristic processing units, but can also be realized as a semiconductor integrated circuit that realizes part of or the entirety of the vehicle-mounted device or a vehicle-mounted network system that includes the vehicle-mounted device.

An aspect of the present disclosure can not only be realized as a management device that includes these characteristic processing units, but can also be realized as a semiconductor integrated circuit that realizes part of or the entirety of the management device or a communication system that includes the management device.

### Advantageous Effects of the Present Disclosure

According to the present disclosure, it is possible to detect a failure in a vehicle in advance.

### BRIEF DESCRIPTION OF DRAWINGS

FIG. 1 is a diagram showing the configuration of a vehicle-mounted network system according to a first embodiment of the present disclosure.

FIG. 2 is a diagram showing the configuration of a switch device according to the first embodiment of the present disclosure.

FIG. 3 is a diagram showing the configuration of a functional unit according to the first embodiment of the present disclosure.

FIG. 4 is a diagram illustrating a method for measuring an initial value of a propagation delay time of data between vehicle-mounted devices according to the first embodiment of the present disclosure.

FIG. 5 is a diagram illustrating a method for measuring a propagation delay time between vehicle-mounted devices after outgoing inspection according to the first embodiment of the present disclosure.

FIG. 6 is a diagram showing an example of the configuration of a transmission line for communication data between a switch device and a functional unit according to the first embodiment of the present disclosure.

FIG. 7 is a diagram illustrating Example 1 of anomaly determination performed by the determination unit of the switch device according to the first embodiment of the present disclosure.

FIG. 8 is a diagram illustrating Example 2 of anomaly determination performed by the determination unit of the switch device according to the first embodiment of the present disclosure.

FIG. 9 is a diagram showing an example of a correspondence table showing a correspondence between a threshold value set by the determination unit of the switch device according to the first embodiment of the present disclosure and a state of the vehicle.

FIG. 10 is a diagram illustrating Example 3 of anomaly determination performed by the determination unit of the switch device according to the first embodiment of the present disclosure.

FIG. 11 is a flowchart defining an example of the operation procedure in which the switch device according to the first embodiment of the present disclosure performs anomaly determination on a transmission line and makes a notification regarding a determination result.

FIG. 12 is a flowchart defining an example of the operation procedure in which the switch device according to the first embodiment of the present disclosure performs anomaly determination on a transmission line and makes a notification regarding a determination result.

FIG. 13 is a flowchart defining an example of the operation procedure in which the switch device according to the first embodiment of the present disclosure performs anomaly determination on a transmission line and makes a notification regarding a determination result.

FIG. 14 is a diagram showing the configuration of a communication system according to a second embodiment of the present disclosure.

FIG. 15 is a diagram showing the configuration of a management device according to the second embodiment of the present disclosure.

FIG. 16 is a diagram illustrating Example 1 of anomaly determination performed by the management device according to the second embodiment of the present disclosure.

FIG. 17 is a diagram illustrating Example 1 of anomaly determination performed by the management device according to the second embodiment of the present disclosure.

FIG. 18 is a diagram illustrating Example 2 of anomaly determination performed by the management device according to the second embodiment of the present disclosure.

FIG. 19 is a diagram showing an example of the sequence of processing for performing anomaly determination on a vehicle of interest, in the communication system according to the second embodiment of the present disclosure.

FIG. 20 is a flowchart defining an example of the operation procedure in which the management device according to the second embodiment of the present disclosure performs anomaly determination.

FIG. 21 is a flowchart defining an example of the operation procedure in which the management device according to the second embodiment of the present disclosure performs anomaly determination.

### DETAILED DESCRIPTION OF PREFERRED EMBODIMENTS

First, embodiments of the present disclosure will be enumerated and described.

### First Aspect

A first aspect of the present disclosure is directed to a vehicle-mounted device that can be mounted in a vehicle, including: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit.

With this configuration, it is possible to determine whether or not there is an anomaly in a transmission line between vehicle-mounted devices, using the propagation delay time of data, thereby making it possible to detect a failure in a vehicle in advance.

### Second Aspect

In a second aspect, it is also possible that the determination unit performs the anomaly determination based on a history of the propagation delay time.

With this configuration, it is possible to determine that no anomaly has occurred in the transmission line even in the case in which the propagation delay time temporarily becomes long due to the influence of noise or the like, thereby making it possible to obtain a more accurate determination result.

### Third Aspect

In a third aspect, it is also possible that the determination unit performs the anomaly determination based on the propagation delay time and a threshold value, and changes the threshold value according to a state of the vehicle.

For example, the propagation delay time trends to be long when the communication load on the vehicle is large, even in the case in which no anomaly has occurred in the transmission line. With this configuration, it is possible to obtain a more accurate determination result according to the state of the vehicle by suppressing erroneous determination by setting a larger threshold value.

### Fourth Aspect

In a fourth aspect, it is also possible that the measurement unit determines whether or not to perform processing for measuring the propagation delay time, based on a communication load on the transmission line of the data.

With this configuration, it is possible to perform anomaly determination based on the propagation delay time while avoiding situations in which the communication load on a transmission line is large, that is, the propagation delay time tends to be long, for example, thereby making it possible to obtain a more accurate determination result by suppressing erroneous determination. Furthermore, it is possible to reduce the processing load on the vehicle-mounted device by reducing the number of times the propagation delay time is measured.

### Fifth Aspect

In a fifth aspect, it is also possible that the vehicle-mounted device further includes a notification unit configured to perform an anomaly notification operation that makes a notification regarding a determination result from the determination unit, and the notification unit changes the content of the anomaly notification operation according to the type of transmission line in which an anomaly has occurred.

With this configuration, it is possible to make a more appropriate notification based on the degree of need for a notification to a user, for example.

### Sixth Aspect

A sixth aspect of the present disclosure is directed to a management device including: an acquisition unit configured to acquire positional information regarding a vehicle of interest in which a propagation delay time of data between vehicle-mounted devices mounted in the vehicle of interest satisfies a predetermined condition; and a determination unit configured to perform anomaly determination on a transmission line of the data in the vehicle of interest, based on the positional information regarding the vehicle of interest acquired by the acquisition unit and other information.

With this configuration, it is possible to determine whether the cause of a long propagation delay time in a vehicle of interest is in a transmission line in the vehicle of interest or in the driving environment of the vehicle of interest, for example, thereby making it possible to more accurately determine whether or not an anomaly has occurred in a transmission line in the vehicle of interest. Accordingly, it is possible to detect a failure in the vehicle in advance.

### Seventh Aspect

In a seventh aspect, it is also possible that the other information is positional information regarding another vehicle in which a propagation delay time of data between vehicle-mounted devices mounted in the other vehicle satisfies a predetermined condition.

With this configuration in which anomaly determination is performed based on the positional information regarding a plurality of vehicles including a vehicle of interest in this manner, for example, it is possible to obtain a more accurate determination result by specifying an area in which the propagation delay time trends to be long.

### Eighth Aspect

An eighth aspect of the present disclosure is directed to an anomaly determination method for use by a vehicle-mounted device mounted in a vehicle, including: a step of measuring a propagation delay time of data between the vehicle-mounted device and another vehicle-mounted device mounted in the vehicle; and a step of performing anomaly determination on a transmission line of the data, based on the measured propagation delay time.

With this method, it is possible to determine whether or not there is an anomaly in a transmission line between vehicle-mounted devices, using the propagation delay time of data, thereby making it possible to detect a failure in a vehicle in advance.

### Ninth Aspect

A ninth aspect of the present disclosure is directed to an anomaly determination method for use by a management device, including: a step of acquiring positional information regarding a vehicle of interest in which a propagation delay time of data between vehicle-mounted devices mounted in the vehicle of interest satisfies a predetermined condition; and a step of performing anomaly determination on a transmission line of the data in the vehicle of interest, based on the acquired positional information regarding the vehicle of interest and other information.

With this method, it is possible to determine whether the cause of a long propagation delay time in a vehicle of interest is in a transmission line in the vehicle of interest or in the driving environment of the vehicle of interest, for example, thereby making it possible to more accurately determine whether or not an anomaly has occurred in a transmission line in the vehicle of interest. Accordingly, it is possible to detect a failure in the vehicle in advance.

### Tenth Aspect

A tenth aspect of the present disclosure is directed to an anomaly determination program for use by a vehicle-mounted device mounted in a vehicle, for causing a computer to function as: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit.

With this configuration, it is possible to determine whether or not there is an anomaly in a transmission line between vehicle-mounted devices, using the propagation delay time of data, thereby making it possible to detect a failure in a vehicle in advance.

### Eleventh Aspect

An eleventh aspect of the present disclosure is directed to an anomaly determination program for use by a management device, for causing a computer to function as: an acquisition unit configured to acquire positional information regarding a vehicle of interest in which a propagation delay time of data between vehicle-mounted devices mounted in the vehicle of interest satisfies a predetermined condition; and a determination unit configured to perform anomaly determination on a transmission line of the data in the vehicle of interest, based on the positional information regarding the vehicle of interest acquired by the acquisition unit and other information.

With this configuration, it is possible to determine whether the cause of a long propagation delay time in a vehicle of interest is in a transmission line in the vehicle of interest or in the driving environment of the vehicle of interest, for example, thereby making it possible to more accurately determine whether or not an anomaly has occurred in a transmission line in the vehicle of interest. Accordingly, it is possible to detect a failure in the vehicle in advance.

Hereinafter, embodiments of the present disclosure will be described with reference to the drawings. Note that the same or corresponding constituent elements in the drawings are denoted by the same reference numerals, and a description thereof will not be repeated. Furthermore, at least portions of the embodiments to be described below may be combined suitably.

### First Embodiment

### Configuration and Basic Operation

### Overall Configuration

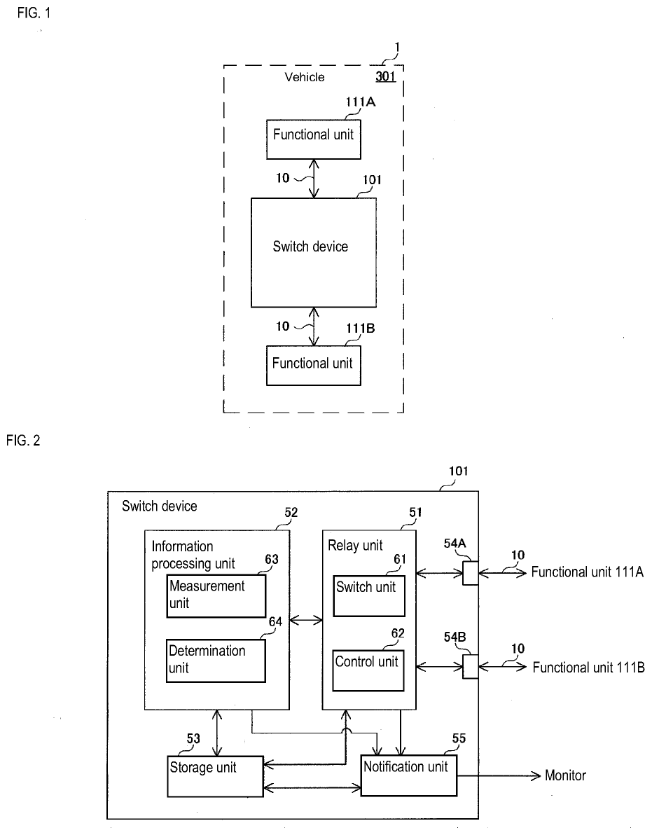

FIG. 1 is a diagram showing the configuration of a vehicle-mounted network system according to a first embodiment of the present disclosure. Referring to FIG. 1, a vehicle-mounted network system 301 is mounted in a vehicle 1 and includes a switch device 101 and a plurality of functional units 111. FIG. 1 shows two functional units 111A and 111B as examples of the functional units 111. The switch device 101 and the functional units 111 are vehicle-mounted devices, and are ECUs (Electronic Control Units), for example.

The switch device 101 is connected to the plurality of functional units 111 via Ethernet (registered trademark) cables 10, for example, and can communicate with the plurality of functional units 111 connected to the switch device. Specifically, the switch device 101 performs relay processing for relaying data from a functional unit 111 to another functional unit 111. Information is exchanged between the switch device 101 and the functional units 111, for example, using Ethernet frames containing IP packets.

The functional units 111 are external communication ECUs, sensors, cameras, navigation devices, automatic operation processing ECUs, engine control devices, AT (Automatic Transmission) control devices, HEV (Hybrid Electric Vehicle) control devices, brake control devices, chassis control devices, steering control devices, instrument display control devices, or the like.

### Configuration of Switch Device and Functional Unit

### (a) Configuration of Switch Device

FIG. 2 is a diagram showing the configuration of a switch device according to the first embodiment of the present disclosure. Referring to FIG. 2, the switch device 101 includes a relay unit 51, an information processing unit 52, a storage unit 53, a plurality of communication ports 54, and a notification unit 55. The relay unit 51, the information processing unit 52, and the notification unit 55 are realized by processors such as CPUs (Central Processing Units) or DSPs (Digital Signal Processors), for example. The storage unit 53 is a non-volatile memory, for example. The relay unit 51 includes a switch unit 61 and a control unit 62. The information processing unit 52 includes a measurement unit 63 and a determination unit 64.

The communication ports 54 are terminals to which an Ethernet cable 10 can be connected, for example. Note that the communication ports 54 may be terminals of an integrated circuit. Each of the plurality of communication ports 54 is connected to one of the plurality of functional units 111 via the Ethernet cable 10. In this example, a communication port 54A is connected to the functional unit 111A, and a communication port 54B is connected to the functional unit 111B.

The storage unit 53 stores an address table Tb1 showing the correspondence between the port number of a communication port 54 and the MAC (Media Access Control) address of a functional unit 111 to which the communication port is connected.

The switch unit 61 relays data between other vehicle-mounted devices. That is to say, when the switch unit 61 receives an Ethernet frame transmitted from a functional unit 111 via the communication port 54 corresponding to the functional unit 111, the switch unit 61 performs relay processing on the received Ethernet frame.

More specifically, the switch unit 61 refers to the address table Tb1 stored in the storage unit 53 and specifies a port number corresponding to the destination MAC address included in the received Ethernet frame. Then, the switch unit 61 transmits the received Ethernet frame from the communication port 54 of the specified port number.

### (b) Configuration of Functional Unit

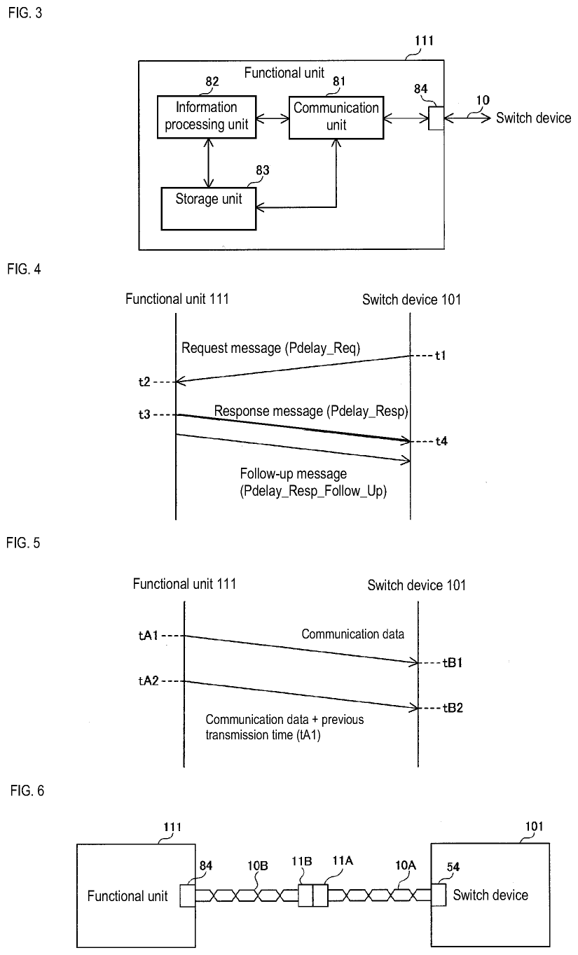

FIG. 3 is a diagram showing the configuration of a functional unit according to the first embodiment of the present disclosure. Referring to FIG. 3, the functional unit 111 includes a communication unit 81, an information processing unit 82, a storage unit 83, and a communication port 84. The communication unit 81 and the information processing unit 82 are realized by processors such as CPUs or DSPs, for example. The storage unit 83 is a non-volatile memory, for example. The communication port 84 is a terminal to which an Ethernet cable 10 can be connected, for example. Note that the communication port 84 may be a terminal of an integrated circuit or the like. The communication port 84 is connected to the switch device 101 via the Ethernet cable 10.

### (c) Measurement of Propagation Delay Time of Data Between Functional Unit and Switch Device

(c-1) Measurement of Initial Value of Propagation Delay Time

FIG. 4 is a diagram illustrating a method for measuring an initial value of a propagation delay time of data between vehicle-mounted devices according to the first embodiment of the present disclosure.

Referring to FIGS. 2 to 4, the measurement unit 63 of the switch device 101 measures the initial value of a propagation delay time of data between the switch device 101 and each functional unit 111 when the switch device 101 and the functional unit 111 are operating properly. The initial value of the propagation delay time is hereinafter also referred to as an initial value D1.

More specifically, the measurement unit 63 transmits a request message (Pdelay_Req) to request time information for use in measurement of the initial value D1, via the relay unit 51 and the communication port 54 to the functional unit 111 at the time of outgoing inspection of the vehicle 1, for example.

The communication unit 81 of the functional unit 111 receives the request message transmitted from the switch device 101 via the communication port 84 and outputs the received request message to the information processing unit 82. The information processing unit 82 receives the request message from the communication unit 81, and then outputs a response message (Pdelay_Resp) in response to the request message, to the communication unit 81. The communication unit 81 transmits the response message received from the information processing unit 82, via the communication port 84 to the switch device 101. At this time, the information processing unit 82 transmits the response message containing a reception time t2 of the request message.

Furthermore, after transmission of the response message, the information processing unit 82 outputs a follow-up message (Pdelay_Resp_Follow_Up) containing a transmission time t3 of the response message, to the communication unit 81. The communication unit 81 transmits the follow-up message received from the information processing unit 82, via the communication port 84 to the switch device 101.

The control unit 62 of the switch device 101 receives the response message and the follow-up message transmitted from a functional unit 111, via the communication port 54. Then, the control unit 62 notifies the information processing unit 52 of the time t2 contained in the response message and the time t3 contained in the follow-up message.

Furthermore, the control unit 62 notifies the information processing unit 52 of a transmission time t1 of the request message and a reception time t4 of the response message. More specifically, the switch device 101 includes an unshown counter. The control unit 62 notifies the information processing unit 52 of the count value of the counter at the time when the request message is transmitted, as the transmission time t1. Furthermore, the control unit 62 notifies the information processing unit 52 of the count value of the counter at the time when the response message is received, as the reception time t4.

The measurement unit 63 of the information processing unit 52 measures an initial value D1 of a propagation delay time of data between the functional unit 111 and the switch device 101, based on the times t1, t2, t3, and t4 notified by the control unit 62. Specifically, the measurement unit 63 calculates the initial value D1=((t4−t1)−(t3−t2))/2. The measurement unit 63 calculates the initial value D1 for each functional unit 111, and stores a combination of the calculated initial value D1 and the identification information regarding the corresponding functional unit 111, in the storage unit 53.

(c-2) Measurement of Propagation Delay Time after Outgoing Inspection

FIG. 5 is a diagram illustrating a method for measuring a propagation delay time between vehicle-mounted devices after outgoing inspection according to the first embodiment of the present disclosure.

Referring to FIGS. 2, 3, and 5, the measurement unit 63 of the switch device 101 measures, for each functional unit 111, a propagation delay time DT of data between the switch device 101 and the functional unit 111 after outgoing inspection of the vehicle 1, for example.

More specifically, the information processing unit 82 of the functional unit 111 periodically or occasionally outputs communication data to the communication unit 81. The communication unit 81 transmits the communication data received from the information processing unit 82, via the communication port 84 to the switch device 101. Furthermore, the information processing unit 82 outputs communication data containing a transmission time tA1 of the previously transmitted communication data, to the communication unit 81, at the time when next communication data is transmitted. Specifically, the information processing unit 82 outputs communication data with a time stamp indicating the transmission time tA1, to the communication unit 81. The communication unit 81 transmits the communication data received from the information processing unit 82, via the communication port 84 to the switch device 101.

The control unit 62 of the switch device 101 receives the communication data transmitted from a functional unit 111, via the communication port 54, and notifies the information processing unit 52 of the time tA1 contained in the received communication data. At this time, the control unit 62 notifies the information processing unit 52 of the identification information regarding the functional unit 111 from which the communication data was transmitted, together with the time tA1 contained in the communication data, for example.

Furthermore, the control unit 62 notifies the information processing unit 52 of a reception time tB1 of communication data received from the functional unit 111, the communication data being received one before the most recently received communication data. At this time, the control unit 62 notifies the information processing unit 52 of the identification information regarding the functional unit 111 from which the communication data was transmitted, together with the reception time tB1 of the communication data, for example.

The measurement unit 63 of the information processing unit 52 measures the propagation delay time DT of the data between the switch device and the corresponding functional unit 111, based on the times tA1 and tB1 notified by the control unit 62. More specifically, the measurement unit 63 calculates the propagation delay time DT=tB1−tA1. Then, the measurement unit 63 notifies the determination unit 64 of the calculated propagation delay time DT and the identification information regarding the corresponding functional unit 111, for example. The measurement unit 63 measures the propagation delay time DT for each functional unit 111 in the manner described above.

Note that the measurement unit 63 is not limited to a configuration that measures the propagation delay time DT each time the switch device 101 receives communication data from the functional unit 111. For example, the control unit 62 of the switch device 101 monitors communication data transmitted and received between the functional unit 111 and the switch device 101, and notifies the measurement unit 63 of the communication load with respect to the functional unit 111. Then, the measurement unit 63 determines whether or not to perform processing for measuring the propagation delay time DT, according to the communication load notified by the control unit 62. For example, the measurement unit 63 determines not to measure the propagation delay time DT in the case in which the communication load is greater than a predetermined value.

Furthermore, the control unit 62 of the switch device 101 may notify the functional unit 111 of the communication load with respect to the functional unit 111. For example, the functional unit 111 causes communication data that is to be transmitted to the switch device 101 not to contain the transmission time of the previous communication data, in the case in which the communication load notified by the switch device 101 is greater than a predetermined value. In this case, since the communication data from the functional unit 111 does not contain the transmission time of the previous communication data, the switch device 101 does not measure the propagation delay time DT of the data between the switch device 101 and the functional unit 111.

### Anomaly Determination on Transmission Line

FIG. 6 is a diagram showing an example of the configuration of a transmission line for communication data between a switch device and a functional unit according to the first embodiment of the present disclosure.

Referring to FIG. 6, the transmission line between the switch device 101 and the functional unit 111 includes the communication port 54 of the switch device 101, an Ethernet cable 10A connected to the communication port 54, the communication port 84 of the functional unit 111, an Ethernet cable 10B connected to the communication port 84, a relay connector 11A connected to the Ethernet cable 10A, and a relay connector 11B connected to the Ethernet cable 10B, for example. The Ethernet cables 10A and 10B are examples of the Ethernet cable 10. The Ethernet cable 10A and the Ethernet cable 10B are connected by mating the relay connector 11A and the relay connector 11B.

Vibration of the vehicle 1 and the like cause impedance mismatch or increased crosstalk at a mating point between the relay connector 11A and the relay connector 11B or at a portion of the Ethernet cable 10 that is untwisted for connection with the relay connector 11. Furthermore, deterioration over time of part of or the entirety of the transmission line and the like also may cause impedance mismatch or increased crosstalk. If such situations continue, for example, an anomaly may occur in the transmission line between the switch device 101 and the functional unit 111, thereby making it impossible to perform proper communication via the transmission line.

Therefore, the determination unit 64 of the switch device 101 performs anomaly determination on the transmission line of data between the functional unit 111 and the switch device 101, based on the propagation delay time DT measured by the measurement unit 63. Accordingly, it is possible to detect a failure in the vehicle 1 in advance. Hereinafter, specific examples of anomaly determination that is performed by the determination unit 64 will be described.

### (a) Example 1

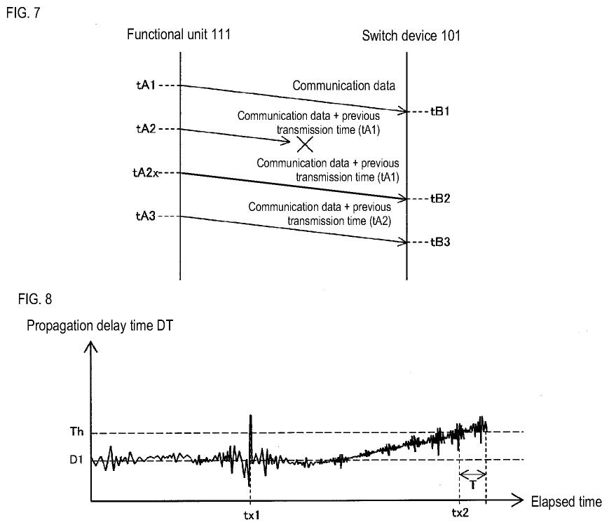

FIG. 7 is a diagram illustrating Example 1 of anomaly determination performed by the determination unit of the switch device according to the first embodiment of the present disclosure.

Referring to FIGS. 2 and 7, if the propagation delay time DT is greater than the initial value D1, the determination unit 64 of the switch device 101 determines that an anomaly has occurred in the corresponding transmission line. More specifically, if the determination unit 64 receives a notification regarding the propagation delay time DT and the identification information regarding the corresponding functional unit 111 from the measurement unit 63, the determination unit 64 specifies an initial value D1 corresponding to the identification information out of the initial values D1 of the propagation delay times for the respective functional units 111 stored in the storage unit 53, for example.

Then, the determination unit 64 compares the specified initial value D1 and the propagation delay time DT notified by the measurement unit 63, thereby determining whether or not an anomaly has occurred in the transmission line of data between the corresponding functional unit 111 and the switch device 101. For example, if the propagation delay time DT is greater than the initial value D1, the determination unit 64 determines that an anomaly has occurred in the corresponding transmission line, and outputs determination information indicating the determination result to the notification unit 55.

Specifically, as shown in FIG. 7, it is assumed that the functional unit 111 transmits communication data to the switch device 101 at a time tA1, and then transmits next communication data to the switch device 101 at transmission time tA2. The communication data transmitted at the time tA2 contains the transmission time tA1 of the previous communication data.

It is assumed that the communication data transmitted at the time tA2, that is, the communication data containing the transmission time tA1 fails to be transmitted. In this case, the functional unit 111 retransmits the communication data containing the transmission time tA1 at a time tA2x that is after the time tA2. Then, it is assumed that the switch device 101 receives, at a time tB2, the communication data transmitted at the time tA2x.

Furthermore, it is assumed that the functional unit 111 transmits communication data to the switch device 101 at the time tA2x, and then transmits next communication data to the switch device 101 at a transmission time tA3. The communication data transmitted at the time tA3 contains the transmission time tA2 of the previous communication data. Then, it is assumed that the switch device 101 receives, at a time tB3, the communication data transmitted at the time tA3.

In this case, the measurement unit 63 of the switch device 101 uses the time tA2 contained in the most recently received communication data and the reception time tB2 of the communication data received one before the communication data to calculate the propagation delay time DT (=tB2−tA2) of data, and notifies the determination unit 64 of the calculated propagation delay time DT.

As mentioned above, the functional unit 111 transmits communication data at the time tA2, and then retransmits the communication data at the time tA2x due to a transmission failure of the communication data. Thus, the propagation delay time DT (=tB2−tA2) is greater than the propagation delay time under normal conditions, that is, the initial value D1 of the propagation delay time (DT>D1). In such a case, the determination unit 64 of the switch device 101 determines that an anomaly has occurred in the corresponding transmission line.

### (b) Example 2

The determination unit 64 may be configured to perform the anomaly determination based on a history of the propagation delay time DT, instead of performing the anomaly determination described in “(a) Example 1”. For example, if the propagation delay time DT tends to be long, the determination unit 64 determines that an anomaly has occurred in the corresponding transmission line.

Specifically, the measurement unit 63 measures the propagation delay time DT, and then stores the measured propagation delay time DT in association with time information indicating the current time, in the storage unit 53. If the propagation delay time DT is newly stored in the storage unit 53, the determination unit 64 refers to a plurality of combinations of the propagation delay time DT and the time information already stored in the storage unit 53. Then, if the propagation delay time DT continues to be greater than or equal to a threshold value Th (DT>Th) for a predetermined period of time T or longer, the determination unit 64 determines that an anomaly has occurred in the corresponding transmission line. For example, threshold value Th is greater than the initial value D1 (Th>D1).

FIG. 8 is a diagram illustrating Example 2 of anomaly determination performed by the determination unit of the switch device according to the first embodiment of the present disclosure. FIG. 8 shows an example of the time-series change in the propagation delay time DT measured by the measurement unit 63 of the switch device 101. In FIG. 8, the horizontal axis indicates the elapsed time, and the vertical axis indicates the propagation delay time DT.

Referring to FIG. 8, it is assumed that the propagation delay time DT is less than the threshold value Th (DT<Th) in the period before a time tx1, and the propagation delay time DT temporarily becomes greater than the threshold value Th (DT>Th) at the time tx1. Furthermore, it is assumed that the propagation delay time DT becomes less than the threshold value Th again in the period after the time tx1 and before a time tx2, and the propagation delay time DT continues to be greater than the threshold value Th after the time tx2 for the predetermined period of time T or longer.

In this case, the determination unit 64 of the switch device 101 determines that an anomaly has occurred in the corresponding transmission line, in the anomaly determination that is performed after the time when the predetermined period of time T has passed from the time tx2, for example.

Note that the determination unit 64 may compare the difference (DT−D1) between the propagation delay time DT and the initial value D1 with another threshold value Thx, instead of comparing the propagation delay time DT and the threshold value Th. In this case, if the difference (DT−D1) continues to be greater than or equal to the threshold value Thx for a predetermined period of time T or longer, the determination unit 64 determines that an anomaly has occurred in the corresponding transmission line, for example.

Furthermore, the determination unit 64 may compare the propagation delay time DT and the threshold value Th to perform the anomaly determination based on the number of times that the propagation delay time DT becomes greater than or equal to the threshold value Th. For example, if the above-mentioned number of times per hour is greater than or equal to a threshold value or if the above-mentioned number of times during the period from when the ignition switch is switched on to the current time is greater than or equal to a threshold value, the determination unit 64 determines that an anomaly has occurred in the corresponding transmission line.

Furthermore, the propagation delay time DT and the time information may be stored by the determination unit 64 instead of the measurement unit 63. That is to say, the measurement unit 63 may notify the determination unit 64 of the measured propagation delay time DT and the current time, and the determination unit 64 may store the notified propagation delay time DT and time information indicating the notified time in the storage unit 53. Furthermore, in this case, before storing the notified propagation delay time DT, the determination unit 64 may compare the propagation delay time DT and the threshold value Th, and store the propagation delay time DT and the time information in the storage unit 53 in the case in which the propagation delay time DT is greater than or equal to the threshold value Th.

### (c) Example 3

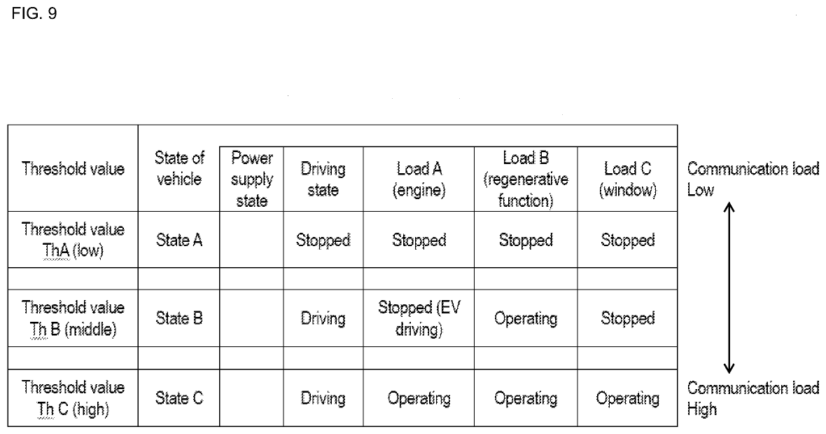

In the configuration in which the determination unit 64 performs the anomaly determination based on the propagation delay time DT and the threshold value Th, the determination unit 64 may change the threshold value Th according to the state of the vehicle 1. For example, in the configuration in which the determination unit 64 compares the propagation delay time DT and the threshold value Th and performs the anomaly determination based on the comparison result, the determination unit 64 changes the threshold value Th according to the state of the vehicle 1. FIG. 9 is a diagram showing an example of a correspondence table showing a correspondence between a threshold value set by the determination unit of the switch device according to the first embodiment of the present disclosure and a state of the vehicle.

Referring to FIGS. 2 and 9, the storage unit 53 of the switch device 101 stores a correspondence table Tb2 showing a correspondence between the threshold value Th and the state of the vehicle 1. The state of the vehicle 1 is determined, for example, according to a combination the following states: power supply state, driving state, engine operating state, regenerative function state, and window operating state.

Specifically, the state of the vehicle 1 when the ignition switch is off, the vehicle is stopped, the engine is stopped, the regenerative function is not operating, and the windows are not operating is taken as “state A”. The state of the vehicle 1 when the ignition switch is on, the vehicle is driving, the engine is stopped due to electric vehicle (EV) driving, the regenerative function is operating, and the windows are not operating is taken as “state B”. The state of the vehicle 1 when the ignition switch is on, the vehicle is driving, the engine is operating, the regenerative function is operating, and the windows are operating is taken as “state C”. The communication load on the vehicle-mounted network system 301 is smaller in the order of the state A, the state B, and the state C.

For example, the control unit 62 of the switch device 101 determines the state of the vehicle 1, by periodically or occasionally monitoring communication data transmitted and received between the plurality of functional units 111 via the switch device 101, thereby monitoring the states of the functions such as the ignition switch. Then, the control unit 62 notifies the information processing unit 52 of the determined state of the vehicle 1. Note that, although FIG. 9 shows three states consisting of the state A, the state B, and the state C as examples of the states of vehicle 1, the states of the vehicle 1 are not limited to these three states.

In the correspondence table Tb2, threshold values ThA, ThB, and ThC are respectively associated with the state A, B, and C. The set value is smaller in the order of the threshold values ThA, ThB, and ThC. That is to say, the larger the communication load on the vehicle-mounted network system 301, the larger threshold value Th associated.

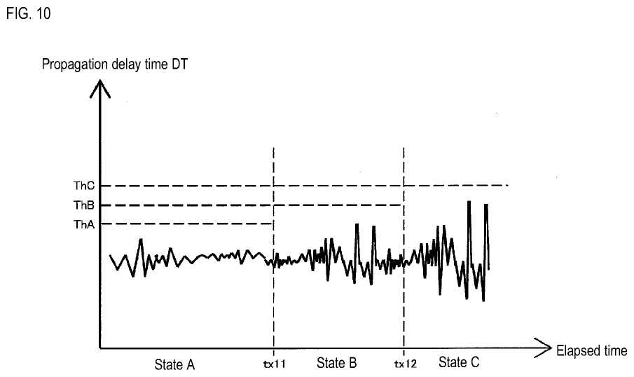

FIG. 10 is a diagram illustrating Example 3 of anomaly determination performed by the determination unit of the switch device according to the first embodiment of the present disclosure. FIG. 10 shows an example of the time-series change in the propagation delay time DT measured by the measurement unit 63 of the switch device 101. FIG. 10, the horizontal axis indicates the elapsed time, and the vertical axis indicates the propagation delay time DT.

Referring to FIGS. 9 and 10, it is assumed that the control unit 62 determines that the state of the vehicle 1 in the period before a time tx11 is “the state A”, the state of the vehicle 1 in the period from the time tx11 to a time tx12 is “the state B”, and the state of the vehicle 1 after the time tx12 is “the state C”.

The determination unit 64 of the information processing unit 52 refers to the correspondence table Tb2 stored in the storage unit 53, and changes the threshold value Th for use in the anomaly determination, according to the state of the vehicle 1 determined by the control unit 62.

Specifically, the determination unit 64 sets the threshold value Th to a threshold value ThA in the period before the time tx11. Then, the determination unit 64 performs the anomaly determination that compares the propagation delay time DT measured by the measurement unit 63 and the threshold value ThA, and determines that an anomaly has occurred in the corresponding transmission line in the case in which the propagation delay time DT is greater than the threshold value ThA, for example.

Furthermore, the determination unit 64 sets the threshold value Th to a threshold value ThB in the period from the time tx11 to the time tx12. Then, the determination unit 64 performs the anomaly determination that compares the propagation delay time DT measured by the measurement unit 63 and the threshold value ThB, and determines that an anomaly has occurred in the corresponding transmission line in the case in which the propagation delay time DT is greater than the threshold value ThB, for example.

Furthermore, the determination unit 64 sets the threshold value Th to a threshold value ThC after the time tx12. Then, the determination unit 64 performs the anomaly determination that compares the propagation delay time DT measured by the measurement unit 63 and the threshold value ThC, and determines that an anomaly has occurred in the corresponding transmission line in the case in which the propagation delay time DT is greater than the threshold value ThC, for example.

In the case in which the determination unit 64 changes the threshold value Th according to the state of the vehicle 1 as well, as with the anomaly determination described in “(b) Example 2” above, the determination unit 64 may determine that an anomaly has occurred in the case in which the propagation delay time DT continues to be greater than or equal to the threshold value Th for a predetermined period of time T or longer, instead of determining that an anomaly has occurred in the case in which the propagation delay time DT temporarily becomes greater than or equal to the threshold value Th.

Furthermore, the determination unit 64 may be configured to compare the difference (DT−D1) between the propagation delay time DT and the initial value D1 with another threshold value Thx, and to change the threshold value Thx according to the state of the vehicle 1, instead of comparing the propagation delay time DT and the threshold value Th.

Furthermore, the determination unit 64 may be configured to compare the propagation delay time DT and the threshold value Th and perform the anomaly determination based on the number of times that the propagation delay time DT becomes greater than or equal to the threshold value Th, and to change the threshold value Th according to the state of the vehicle 1.

Notification and Storage of Determination Result

Referring to FIG. 2 again, the notification unit 55 performs an anomaly notification operation that makes a notification regarding the determination result from the determination unit 64. More specifically, if a determination result to the effect that an anomaly has occurred in a transmission line is obtained, the determination unit 64 outputs determination information indicating the determination result to the notification unit 55, as mentioned above. When the notification unit 55 receives the determination information from the determination unit 64, the notification unit 55 performs an anomaly notification operation that notifies the user of the content of the determination information by displaying it on a monitor or the like mounted in the vehicle 1 and stores the determination information in the storage unit 53, for example.

Furthermore, the notification unit 55 may change the content of the anomaly notification operation according to the type of transmission line in which an anomaly has occurred. More specifically, the ISO26262 standard defines ASIL (Automotive Safety Integrity Level: safety requirement level) as an index of functional safety, and for each safety requirement, the levels QM (Quality Management), A, B, C, and D are assigned in ascending order of level. Functions assigned D require the highest level of safety measures, and functions assigned A require the lowest required safety measures. Functions assigned QM are not related to safety. The storage unit 53 stores ASIL levels for the respective functional units 111 in advance.

When the notification unit 55 receives the determination information from the determination unit 64, the notification unit 55 specifies a functional unit 111 corresponding to the transmission line indicated by the determination information. Furthermore, the notification unit 55 refers to the ASIL level of each functional unit 111 stored in the storage unit 53 and checks the ASIL level corresponding to the specified functional unit 111. Then, if the ASIL level of the specified functional unit 111 is higher than or equal to a predetermined level, the notification unit 55 continues to display the content of the determination information on the monitor until a predetermined operation is performed by the user, for example.

On the other hand, if the ASIL level of the specified functional unit 111 is lower than the predetermined level, the notification unit 55 does not display the content of the determination information on the monitor, for example. Then, if the notification unit 55 again receives, from the determination unit 64, determination information indicating that an anomaly has occurred in the transmission line corresponding to the functional unit 111, the notification unit 55 displays the content of the determination information on the monitor. When the notification unit 55 receives determination information from the determination unit 64, the notification unit 55 stores the determination information in the storage unit 53, regardless of whether or not to display the content of the determination information on the monitor.

Note that the notification unit 55 is not limited to a configuration that performs this sort of anomaly notification operation. For example, if the ASIL level of the specified functional unit 111 is lower than the predetermined level, the notification unit 55 may display the content of the determination information on the monitor for a predetermined period of time, and then turn off the display. Furthermore, the notification unit 55 may be configured to perform an anomaly notification operation that makes a notification of the same content regardless of the type of transmission line in which an anomaly has occurred.

Furthermore, instead of storing the determination information in the storage unit 53 of the switch device 101, the notification unit 55 may store the determination information in another vehicle-mounted device with a diag function.

Furthermore, the notification unit 55 may notify the user that an anomaly has occurred in the transmission line, by turning on an LED (Light Emitting Diode) in the vehicle 1, instead of or in addition to displaying the information on the monitor, for example. In this case, the notification unit 55 changes the lighting state of the LED according to the type of transmission line in which an anomaly has occurred, for example.

### Operation Flow

Next, an operation of the switch device 101 according to the first embodiment of the present disclosure in performing anomaly determination on a transmission line for communication data between the switch device 101 and each functional unit 111 and making a notification regarding a determination result will be described with reference to the drawings.

Each device in the vehicle-mounted network system 301 includes a computer equipped with a memory, and a computational processing unit such as a CPU in the computer reads from the memory and executes a program including some or all of the steps of the following sequence. The programs of these plurality of devices can each be installed from an external source. The programs of these plurality of devices are each distributed as stored in a recording medium.

### Operation Procedure in Performing Anomaly Determination on Transmission Line and Making Notification (Example 1)

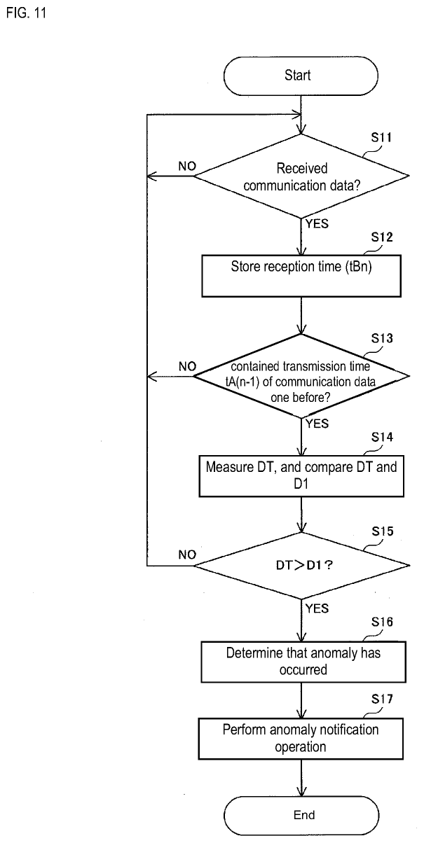

FIG. 11 is a flowchart defining an example of the operation procedure in which the switch device according to the first embodiment of the present disclosure performs anomaly determination on a transmission line and makes a notification regarding a determination result. FIG. 11 corresponds to “(a) Example 1” above.

Referring to FIG. 11, first, the switch device 101 waits until it receives communication data from the functional unit 111 (“NO” in step S11), and if it receives communication data from the functional unit 111 (“YES” in step S11), it stores a reception time tBn of the communication data (step S12).

Next, the switch device 101 checks whether or not the communication data received in step S11 contains a transmission time tA(n−1) of the communication data one before that communication data (step S13).

Next, if the communication data contains a transmission time tA(n−1) of the communication data one before that communication data (“YES” in step S13), the switch device 101 measures the propagation delay time DT (=tBn−tA(n−1)). Then, the switch device 101 compares the measured propagation delay time DT with the initial value D1 corresponding to the functional unit 111 from which the communication data received in step S11 was transmitted, out of the already stored initial values D1 of the plurality of propagation delay times (step S14).

Next, if the propagation delay time DT is greater than the initial value D1 (“YES” in step S15), the switch device 101 determines that an anomaly has occurred in the transmission line between the switch device 101 and the functional unit 111 (step S16). Then, the switch device 101 performs an anomaly notification operation, that is, displays the content of the determination result and stores determination information indicating the determination result (step S17).

On the other hand, if the communication data received in step S11 does not contain a transmission time tA(n−1) of the communication data one before that communication data (“NO” in step S13), or if the measured propagation delay time DT is less than or equal to the initial value D1 (“NO” in step S15), the switch device 101 waits until it receives new communication data from the functional unit 111.

### Operation Procedure in Performing Anomaly Determination on Transmission Line and Making Notification (Example 2)

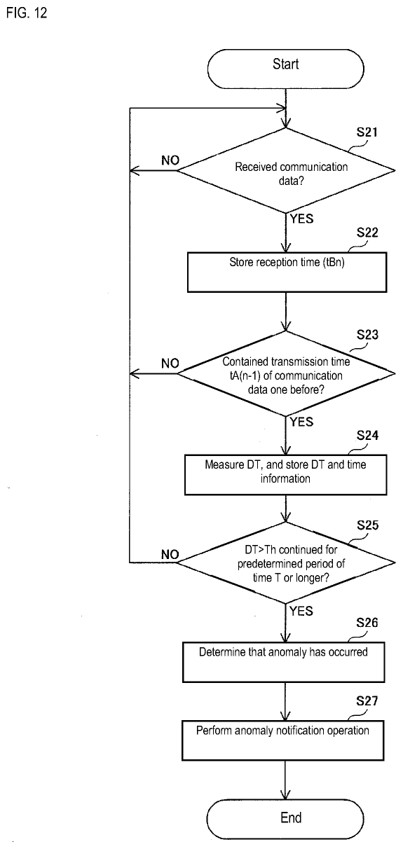

FIG. 12 is a flowchart defining an example of the operation procedure in which the switch device according to the first embodiment of the present disclosure performs anomaly determination on a transmission line and makes a notification regarding a determination result. FIG. 12 corresponds to “(b) Example 2” above.

Referring to FIG. 12, the operation from step S21 to S23 is similar to that from step S11 to S13 shown in FIG. 11, and thus a detailed description thereof will not be repeated.

Next, if the communication data contains a transmission time tA(n−1) of the communication data one before that communication data (“YES” in step S23), the switch device 101 measures the propagation delay time DT (=tBn−tA(n−1). Then, the switch device 101 stores the measured propagation delay time DT in association with time information indicating the current time (step S24).

Next, the switch device 101 refers to a plurality of stored combinations of the propagation delay time DT and the time information, and checks whether or not the propagation delay time DT continues to be greater than the threshold value Th for the predetermined period of time T or longer (step S25).

Next, if the propagation delay time DT continues to be greater than the threshold value Th for the predetermined period of time T or longer, the switch device 101 determines that an anomaly has occurred in the transmission line between the switch device 101 and the functional unit 111 (step S26). Then, the switch device 101 performs an anomaly notification operation, that is, displays the content of the determination result and stores determination information indicating the determination result (step S27).

On the other hand, if the measured propagation delay time DT does not continue to be greater than the threshold value Th for the predetermined period of time T or longer (“NO” in step S25), the switch device 101 waits until it receives new communication data from the functional unit 111.

### Operation Procedure in Performing Anomaly Determination on Transmission Line and Making Notification (Example 3)

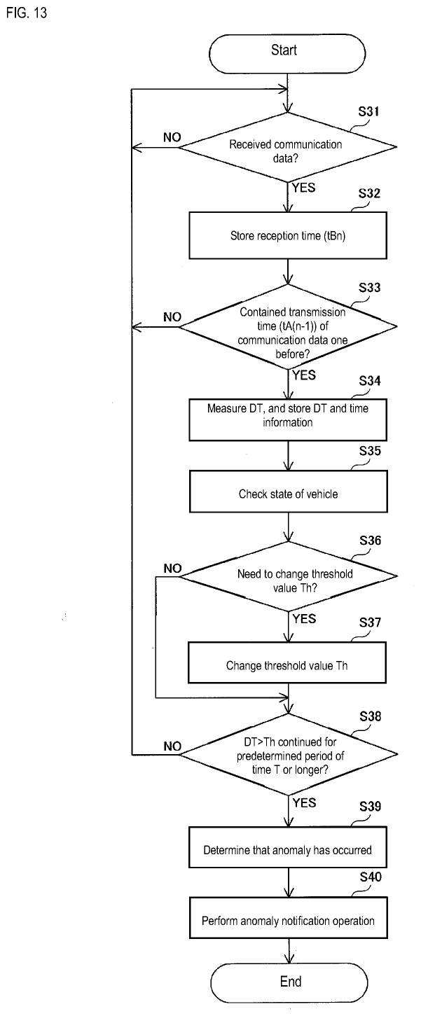

FIG. 13 is a flowchart defining an example of the operation procedure in which the switch device according to the first embodiment of the present disclosure performs anomaly determination on a transmission line and makes a notification regarding a determination result. FIG. 13 corresponds to “(c) Example 3” above.

Referring to FIG. 13, the operation from step S31 to S34 is similar to that from step S21 to S24 shown in FIG. 12, and thus a detailed description thereof will not be repeated.

Next, the switch device 101 determines the state of the vehicle 1 to be one of “the state A”, “the state B”, and “the state C” by monitoring the communication data transmitted and received between the functional units 111, for example (step S35).

Next, the switch device 101 refers to the stored correspondence table Tb2, and checks whether or not the threshold value Th for use in the anomaly determination needs to be changed, based on the state of the vehicle 1 determined in step S35 (step S36).

Next, if it is determined that the threshold value Th needs to be changed (“YES” in step S36), the switch device 101 changes the threshold value Th according to the state of the vehicle 1 (step S37).

Next, the switch device 101 checks whether or not the propagation delay time DT measured in step S34 continues to be greater than the changed threshold value Th for the predetermined period of time T or longer (step S38), for example.

Next, if the propagation delay time DT continues to be greater than the threshold value Th for the predetermined period of time T or longer, the switch device 101 determines that an anomaly has occurred in the transmission line between the switch device 101 and the functional unit 111 (step S39). Then, the switch device 101 performs an anomaly notification operation, that is, displays the content of the determination result and stores determination information indicating the determination result (step S40).

On the other hand, if the measured propagation delay time DT does not continue to be greater than the threshold value Th for the predetermined period of time T or longer (“NO” in step S38), the switch device 101 waits until it receives new communication data from the functional unit 111.

Furthermore, if it is determined based on the determined state of the vehicle 1 that the threshold value Th for use in the anomaly determination does not need to be changed (“NO” in step S36), the switch device 101 performs operations from step S38 onward without changing the threshold value Th.

Note that, in the vehicle-mounted network system 301 according to the first embodiment of the present disclosure described above, the switch device 101 is configured to perform anomaly determination on a transmission line between the switch device 101 and each functional unit 111, but there is no limitation to this, and a vehicle-mounted device other than the switch device 101 may include a unit similar to the switch device 101 and be configured to perform the anomaly determination. Furthermore, the switch device 101 may also have other functions in addition to the functions of relaying communication data between the functional units 111 and performing the anomaly determination.

Next, another embodiment of the present disclosure will be described with reference to the drawings. Note that the same or corresponding constituent elements in the drawings are denoted by the same reference numerals, and a description thereof will not be repeated.

### Second Embodiment

In the first embodiment of the present disclosure described above, the switch device 101 performs the anomaly determination on a transmission line based on a propagation delay time DT of data between the switch device 101 and the corresponding functional unit 111. Meanwhile, in the second embodiment of the present disclosure, a management device 201 performs the anomaly determination on a transmission line in a vehicle 1 in which the propagation delay time DT of data between vehicle-mounted devices mounted in the vehicle 1 satisfies a predetermined condition, based on the positional information regarding the vehicle 1.

### Configuration and Basic Operation

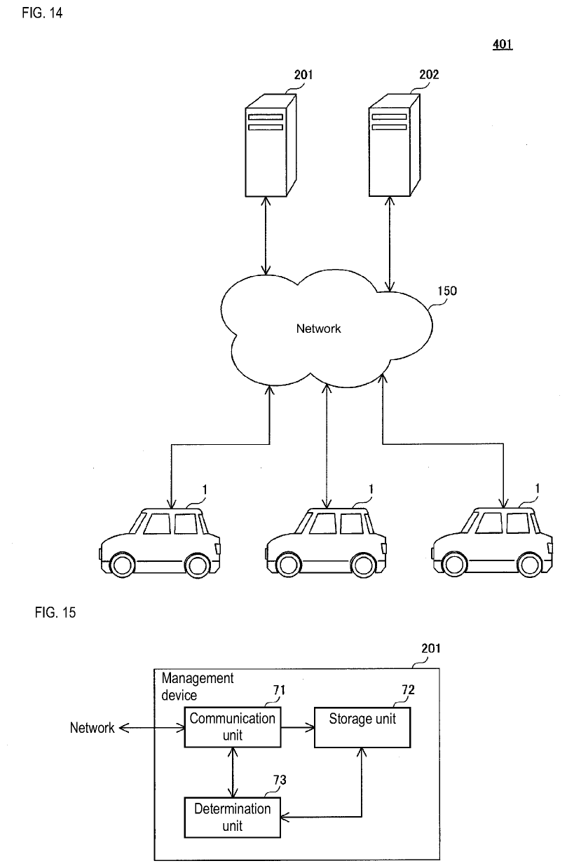

FIG. 14 is a diagram showing the configuration of a communication system according to a second embodiment of the present disclosure. Referring to FIG. 14, a communication system 401 includes a plurality of vehicles 1 each equipped with the vehicle-mounted network system 301, the management device 201, and a weather information management device 202. The management device 201 is a server provided outside the vehicles 1, and transmits and receives information to and from each vehicle 1 via a network 150, for example. The weather information management device 202 is a server provided outside the vehicles 1, and periodically or occasionally transmits weather information to the management device 201 via the network 150, for example.

Referring to FIGS. 1 and 2 again, it is assumed that the functional unit 111A in each vehicle-mounted network system 301 is an external communication ECU. The determination unit 64 of the switch device 101 of each vehicle 1 performs the anomaly determination on a transmission line based on the propagation delay time DT using a method similar to that described in the first embodiment, for example. Then, if the propagation delay time DT satisfies a predetermined condition, that is, if a determination result to the effect that an anomaly has occurred in a transmission line is obtained, the determination unit 64 outputs positional information indicating the current position of the vehicle 1 to the relay unit 51.

The switch unit 61 of the relay unit 51 transmits the positional information received from the determination unit 64, from the communication port 54A to the functional unit 111A. Then, the functional unit 111A transmits the positional information received from the switch device 101, via the network 150 to the management device 201.

FIG. 15 is a diagram showing the configuration of a management device according to the second embodiment of the present disclosure. Referring to FIG. 15, the management device 201 includes a communication unit (acquisition unit) 71, a storage unit 72, and a determination unit 73. The communication unit 71 and the determination unit 73 are realized by processors such as CPUs or DSPs, for example. The storage unit 72 is a non-volatile memory, for example, and stores map information and the like.

The communication unit 71 acquires the positional information regarding a vehicle 1 in which the propagation delay time DT of data between vehicle-mounted devices mounted in the vehicle 1 satisfies a predetermined condition. More specifically, the communication unit 71 receives positional information transmitted from the switch device 101 of the vehicle 1 for which a determination result to the effect that an anomaly has occurred in a transmission line in the vehicle 1 is obtained, via the functional unit 111A and the network 150. Then, the communication unit 71 stores the received positional information in the storage unit 72. The storage unit 72 stores the positional information regarding one or a plurality of vehicles 1 in which the propagation delay time DT satisfies a predetermined condition.

Furthermore, the communication unit 71 receives, via the network 150, weather information transmitted from the weather information management device 202, and stores the received weather information in the storage unit 72. The weather information indicates the temperature, humidity, whether or not there is lightning, and whether or not there is torrential rain for each area, for example.

The determination unit 73 performs the anomaly determination on a transmission line in a vehicle 1, based on the positional information regarding the vehicle 1 and other information acquired by the communication unit 71. The other information is at least one of the map information stored in the storage unit 72, the positional information regarding a vehicle 1 other than the vehicle 1 (hereinafter also referred to as a “vehicle of interest”) on which anomaly determination is to be performed, the positional information being acquired by the communication unit 71, and weather information. The anomaly determination that is performed by the determination unit 73 will be described later in detail. Furthermore, if a determination result to the effect that an anomaly has occurred in a transmission line in the vehicle 1 of interest is obtained, the determination unit 73 transmits determination information indicating the determination result to the vehicle 1 of interest via the communication unit 71 and the network 150.

Referring to FIGS. 1 and 2 again, when the functional unit 111A of the vehicle 1 receives, via the network 150, the determination information transmitted from the management device 201, the functional unit 111A transmits the determination information to the switch device 101. When the control unit 62 of the switch device 101 receives, via the communication port 54A, the determination information transmitted from the functional unit 111A, the control unit 62 outputs the determination information to the notification unit 55. When the notification unit 55 receives the determination information from the control unit 62, the notification unit 55 performs an anomaly notification operation that displays the content of the determination information on a monitor or the like using a method similar to that described in the first embodiment, for example.

### Details of Anomaly Determination

### Example 1

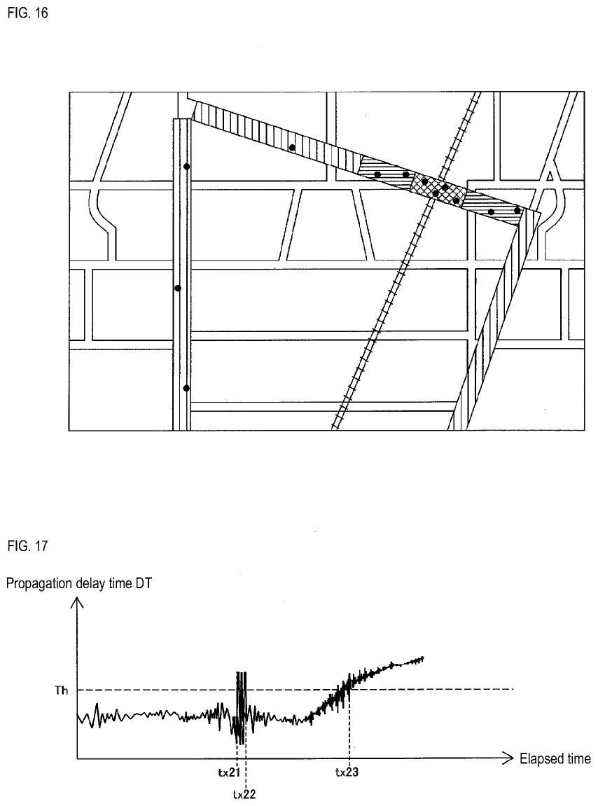

FIGS. 16 and 17 are diagrams illustrating Example 1 of anomaly determination performed by the management device according to the second embodiment of the present disclosure. FIG. 17 shows an example of the time-series change in the propagation delay time DT measured by the measurement unit 63 of the switch device 101 in the vehicle 1 of interest. In FIG. 17, the horizontal axis indicates the elapsed time, and the vertical axis indicates the propagation delay time DT.

Referring to FIGS. 15 to 17, the determination unit 73 of the management device 201 performs the anomaly determination on a transmission line in the vehicle 1 of interest, based on the positional information regarding the vehicle 1 of interest, the positional information regarding one or a plurality of other vehicles 1 in which the propagation delay time DT satisfies a predetermined condition, and the map information.

More specifically, the determination unit 73 refers to one or a plurality of pieces of positional information stored in the storage unit 72 and maps the positions indicated by the respective pieces of positional information onto the map indicated by the map information stored in the storage unit 72, for example. Accordingly, as shown in FIG. 16, the positions of the one or plurality of vehicles 1 where a determination result to the effect that an anomaly had occurred in a transmission line was obtained are mapped on the map.

Furthermore, the determination unit 73 sets a level for each unit area according to the number of mappings per unit area, for example. Specifically, the determination unit 73 sets a level 1 for areas in which the number of mappings per unit area is N1 or greater, a level 2 for areas in which the number of mappings per unit area is N2 (<N1) or greater and less than N1, and a level 3 for areas in which the number of mappings per unit area is less than N2. In FIG. 16, the area in which the level 1 is set is marked with cross hatching, the areas in which the level 2 is set are marked with horizontal line hatching, and the areas in which the level 3 is set are marked with vertical line hatching. The propagation delay time DT in the vehicle 1 traveling in each area tends to be longer in the order of the level 1, the level 2, and the level 3.

As shown in FIG. 17, it is assumed that the vehicle 1 of interest travels in an area at the level 1 in the period from a time tx21 to a time tx22. Furthermore, it is assumed that, in that period, the vehicle 1 of interest determines through anomaly determination that an anomaly has occurred in a transmission line, and transmits positional information indicating its current position to the management unit 201.

If the positional information from the vehicle 1 of interest is newly stored in the storage unit 72, the determination unit 73 of the management device 201 refers to the positional information and the map on which the mapping was performed, and checks the level of the area including the position indicated by the positional information. Then, the determination unit 73 determines whether the cause of the long propagation delay time DT in the vehicle 1 of interest is in a transmission line in the vehicle 1 of interest or in the driving environment of the vehicle 1 of interest, based on the checked level.

Specifically, if the determination unit 73 confirms that the level of the area in which the vehicle 1 of interest is located is “1”, the determination unit 73 specifies the area as a high electric field area in which high-voltage electric lines are mounted in the sky or the like and in which noise tends to occur in data transmission, that is, in which the propagation delay time DT tends to be long. Then, the determination unit 73 determines that the cause of the long propagation delay time DT in the vehicle 1 of interest is in the driving environment of the vehicle 1 of interest, and that no anomaly has occurred in the transmission lines in the vehicle 1 of interest. In this case, the determination unit 73 does not transmit determination information indicating the determination result to the vehicle 1 of interest, for example.

In the vehicle 1 of interest, the determination information from the management device 201 does not arrive after the transmission of the determination information to the management device 201, and thus the switch device 101 of the vehicle 1 of interest does not perform the anomaly notification operation.

Furthermore, as shown in FIG. 17, it is assumed that the vehicle 1 of interest travels in an area at the level 2 or 3 in the period after a time tx23. Furthermore, it is assumed that, in that period, the vehicle 1 of interest determines through anomaly determination that an anomaly has occurred in a transmission line, and transmits positional information indicating its current position to the management unit 201.

If the positional information from the vehicle 1 of interest is newly stored in the storage unit 72, the determination unit 73 of the management device 201 refers to the positional information and the map on which the mapping was performed, and checks the level of the area including the position indicated by the positional information. Then, the determination unit 73 confirms that the level of the area including the position of the vehicle 1 of interest is “2” or “3”, and determines that the cause of the long propagation delay time DT in the vehicle 1 of interest is in an anomaly in a transmission line in the vehicle 1 of interest. Then, the determination unit 73 transmits determination information indicating the determination result via the communication unit 71 and the network 150 to the vehicle 1 of interest.

In the vehicle 1 of interest, the functional unit 111A receives, via the network 150, the determination information transmitted from the management device 201, and transmits the determination information to the switch device 101. When the control unit 62 of the switch device 101 receives, via the communication port 54A, the determination information transmitted from the functional unit 111A, the control unit 62 outputs the determination information to the notification unit 55. When the notification unit 55 receives the determination information from the control unit 62, the notification unit 55 performs an anomaly notification operation that displays the content of the determination information on a monitor or the like using a method similar to that described in the first embodiment, for example.

Note that, if the determination unit 73 performs the anomaly determination without using weather information as described above, the communication system 401 does not have to include the weather information management device 202.

Furthermore, the management device 201 may transmit the positional information acquired from one or a plurality of vehicles 1 and the map information, or the mapping information indicating the map after mapping, to the vehicle 1 of interest. In this case, the vehicle 1 of interest may perform anomaly determination on its own transmission lines, based on the one or plurality of pieces of positional information and the map information or the mapping information received from the management device 201. For example, the switch device 101 of the vehicle 1 of interest specifies the level of its own driving area based on the plurality of pieces of positional information and the map information or the mapping information, and, if the specified level is “1”, the switch device 101 determines that no anomaly has occurred in the transmission lines even in the case in which the propagation delay time DT is greater than the threshold value Th.

### Example 2

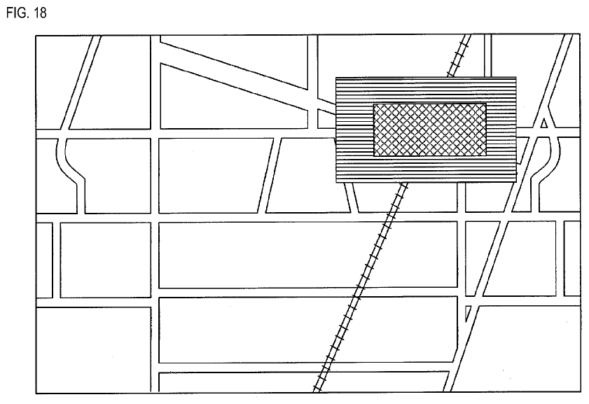

FIG. 18 is a diagram illustrating Example 2 of anomaly determination performed by the management device according to the second embodiment of the present disclosure.

Referring to FIGS. 15 and 18, the determination unit 73 of the management device 201 performs the anomaly determination on a transmission line in the vehicle 1 of interest, based on the positional information acquired from the vehicle 1 of interest, the map information, and the weather information acquired from the weather information management device 202.

More specifically, the determination unit 73 periodically or occasionally refers to the map information and the latest weather information stored in the storage unit 72, for example. The determination unit 73 sets a level “1” for areas in which there is lightning or heavy rain, a level “2” for areas surrounding an area at the level 1, and a level “3” for other areas. In FIG. 18, the area in which the level 1 is set is marked with cross hatching, the area in which the level 2 is set is marked with horizontal line hatching, and the area in which the level 3 is set is not marked with hatching. The propagation delay time DT in the vehicle 1 traveling in each area tends to be longer in the order of the level 1, the level 2, and the level 3.

Furthermore, if positional information is newly stored in the storage unit 72, the determination unit 73 checks the level of the area including the position indicated by the positional information. In this case, it is assumed that there is lightning in that area.

In this case, the determination unit 73 specifies that the vehicle 1 of interest from which the positional information was transmitted is located in an area in which noise tends to occur in data transmission, that is, in which the propagation delay time DT tends to be long. Then, the determination unit 73 determines that the cause of the long propagation delay time DT in the vehicle 1 of interest is in the driving environment of the vehicle 1 of interest, and that no anomaly has occurred in the transmission lines in the vehicle 1 of interest. In this case, the determination unit 73 does not transmit determination information indicating the determination result to the vehicle 1 of interest, for example.

In the vehicle 1 of interest, the determination information from the management device 201 does not arrive after the transmission of the determination information to the management device 201, and thus the switch device 101 of the vehicle 1 of interest does not perform the anomaly notification operation.

On the other hand, if there is neither lightning nor heavy rain in the area in which the vehicle 1 of interest is located, the determination unit 73 determines that the cause of the long propagation delay time DT in the vehicle 1 of interest is in an anomaly in a transmission line in the vehicle 1 of interest. Then, the determination unit 73 transmits determination information indicating the determination result via the communication unit 71 and the network 150 to the vehicle 1 of interest.

In the vehicle 1 of interest, the functional unit 111A receives, via the network 150, the determination information transmitted from the management device 201, and transmits the determination information to the switch device 101. When the control unit 62 of the switch device 101 receives, via the communication port 54A, the determination information transmitted from the functional unit 111A, the control unit 62 outputs the determination information to the notification unit 55. When the notification unit 55 receives the determination information from the control unit 62, the notification unit 55 performs an anomaly notification operation that displays the content of the determination information on a monitor or the like using a method similar to that described in the first embodiment, for example.

Note that the vehicle 1 of interest may receive map information and weather information from the management device 201 and perform the anomaly determination on a transmission line in the vehicle 1 of interest based on the received map information and weather information. That is to say, the switch device 101 of the vehicle 1 of interest checks whether or not there is lightning or heavy rain in its own driving area, based on the map information and the weather information, for example. If there is lightning or heavy rain, it may be determined that no anomaly has occurred in the transmission lines even in the case in which the propagation delay time DT is greater than the threshold value Th.

Furthermore, the determination unit 73 of the management device 201 may perform the anomaly determination using a method other than that used in Examples 1 and 2 above. For example, the determination unit 73 may perform the anomaly determination on a transmission line in the vehicle 1 of interest, based on the plurality of pieces of positional information respectively acquired from the plurality of vehicles 1 including the vehicle 1 of interest, the map information, and the weather information.

Furthermore, each of the plurality of vehicles 1 may transmit, in addition to the positional information indicating the current position at which it is determined that an anomaly has occurred in a transmission line, at least one piece of vehicle information from among determination information indicating the determination result, vehicle type information indicating the type of the vehicle, state information indicating a state of the vehicle, time information indicating the current time, and delay time information indicating the propagation delay time DT used for the anomaly determination, to the management device 201. In this case, the management device 201 can perform the anomaly determination comprehensively considering not only the positional information regarding the vehicle 1 but also the vehicle information regarding the vehicle 1, and thus it is possible to obtain a more accurate determination result.

### Operation Flow

Next, an operation of the management device 201 according to the second embodiment of the present disclosure in performing anomaly determination on a transmission line of data in the vehicle 1 of interest will be described with reference to the drawings.

Each device in the communication system 401 includes a computer equipped with a memory, and a computational processing unit such as a CPU in the computer reads from the memory and executes a program including some or all of the steps of the following sequence. The programs of these plurality of devices can each be installed from an external source. The programs of these plurality of devices are each distributed as stored in a recording medium.

### Operation Procedure of Communication System in Performing Anomaly Determination on Vehicle of Interest

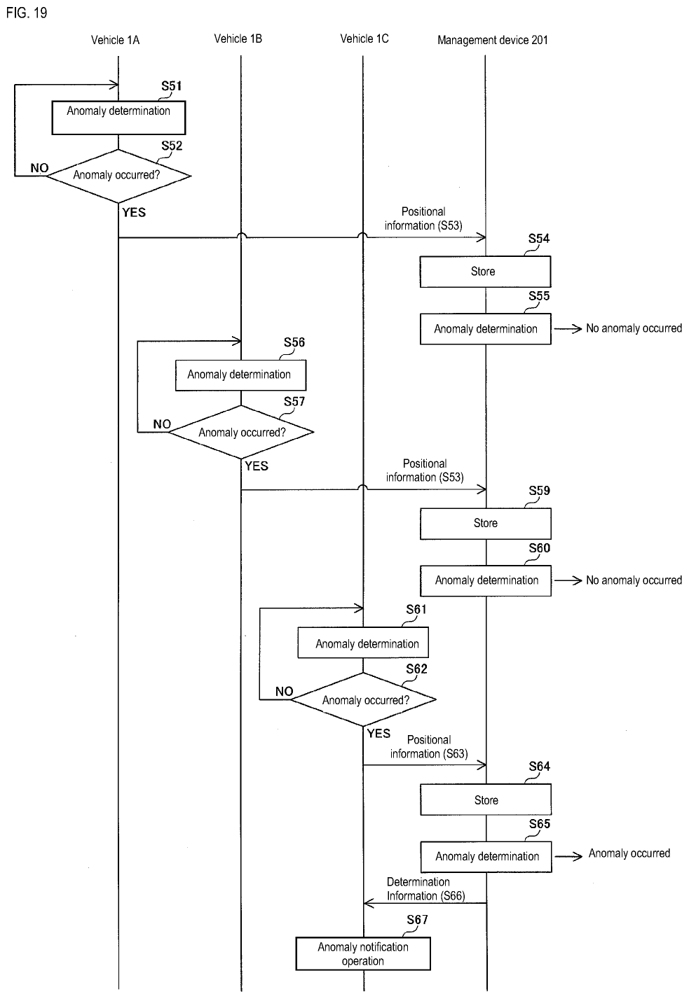

FIG. 19 is a diagram showing an example of the sequence of processing for performing anomaly determination on a vehicle of interest, in the communication system according to the second embodiment of the present disclosure. In this example, it is assumed that vehicles 1A, 1B, and 1C that are three vehicles 1 are included in the communication system 401.

Referring to FIG. 19, first, it is assumed that the switch device 101 of the vehicle 1A performs the anomaly determination on a transmission line in the vehicle 1A (step S51). Then, if the switch device 101 of the vehicle 1A determines that an anomaly has occurred (“YES” in step S52), the switch device 101 transmits positional information indicating the current position of the vehicle 1A, to the management device 201 (step S53). On the other hand, if the switch device 101 of the vehicle 1A determines that no anomaly has occurred (“NO” in step S52), the switch device 101 waits until it performs the next anomaly determination.

Next, when the management device 201 receives the positional information transmitted from the vehicle 1A, the management device 201 stores the positional information (step S54).

Next, the management device 201 performs the anomaly determination on the vehicle 1A serving as a vehicle of interest, based on the stored plurality of pieces of positional information and map information, for example. In this example, it is assumed that the management device 201 obtains a determination result indicating that no anomaly has occurred. In this case, the management device 201 does not transmit determination information indicating the determination result, and waits until it receives other positional information, for example (step S55).

Next, it is assumed that the switch device 101 of the vehicle 1B performs the anomaly determination on a transmission line in the vehicle 1B (step S56). Next, if the switch device 101 of the vehicle 1B determines that an anomaly has occurred (“YES” in step S57), the switch device 101 transmits positional information indicating the current position of the vehicle 1B, to the management device 201 (step S58). On the other hand, if the switch device 101 of the vehicle 1B determines that no anomaly has occurred (“NO” in step S57), the switch device 101 waits until it performs the next anomaly determination.

Next, when the management device 201 receives the positional information transmitted from the vehicle 1B, the management device 201 stores the positional information (step S59).

Next, the management device 201 performs the anomaly determination on the vehicle 1B serving as a vehicle of interest, based on the stored plurality of pieces of positional information and map information, for example. In this example, it is assumed that the management device 201 obtains a determination result indicating that no anomaly has occurred. In this case, the management device 201 does not transmit determination information indicating the determination result, and waits until it receives other positional information, for example (step S60).

Next, it is assumed that the switch device 101 of the vehicle 1C performs the anomaly determination on a transmission line in the vehicle 1C (step S61). Next, if the switch device 101 of the vehicle 1C determines that an anomaly has occurred (“YES” in step S62), the switch device 101 transmits positional information indicating the current position of the vehicle 1C, to the management device 201 (step S63). On the other hand, if the switch device 101 of the vehicle 1C determines that no anomaly has occurred (“NO” in step S62), the switch device 101 waits until it performs the next anomaly determination.

Next, when the management device 201 receives the positional information transmitted from the vehicle 1C, the management device 201 stores the positional information (step S64).

Next, the management device 201 performs the anomaly determination on the vehicle 1C serving as a vehicle of interest, based on the stored plurality of pieces of positional information and map information, for example. In this example, it is assumed that the management device 201 obtains a determination result indicating that an anomaly has occurred. In this case, the management device 201 transmits determination information indicating the determination result, to the vehicle 1C (step S66).

Next, if the switch device 101 of the vehicle 1C receives the determination information transmitted from the management device 201, the switch device 101 performs an anomaly notification operation, that is, displays the content of the determination information and stores the determination information, based on the received determination information (step S67).

### Operation Procedure of Management Device in Performing Anomaly Determination (Example 1)

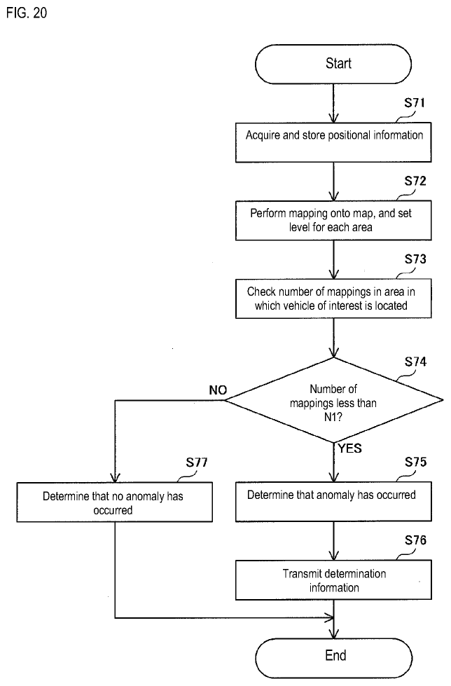

FIG. 20 is a flowchart defining an example of the operation procedure in which the management device according to the second embodiment of the present disclosure performs anomaly determination. FIG. 20 corresponds to “(Example 1)” above.

Referring to FIG. 20, first, the management device 201 acquires positional information transmitted from the switch device 101 of the vehicle 1, and stores the acquired positional information (step S71). Next, the management device 201 maps the position indicated by the newly received positional information onto the map indicated by the stored map information. Then, the management device 201 sets a level for each area according to the number of mappings per unit area (step S72).

Next, the management device 201 checks the vehicle 1 from which the positional information was transmitted, the vehicle 1 being a vehicle of interest, with respect to the number of mappings in the area including the position of the vehicle 1 of interest. That is to say, the management device 201 checks the level of the area (step S73). Next, if the number of mappings in the area is less than a predetermined value N1, that is, if the level of the area is “2” or “3” (“YES” in step S74), the management device 201 determines that an anomaly has occurred in a transmission line in the vehicle 1 of interest (step S75), and transmits determination information indicating the determination result to the vehicle 1 of interest (step S76).

On the other hand, if the number of mappings in the area including the position of the vehicle 1 of interest is the predetermined value N1 or greater, that is, if the level of the area is “1” (“NO” in step S74), the management device 201 determines that no anomaly has occurred in the transmission lines in the vehicle 1 of interest (step S77). In this case, the management device 201 does not transmit determination information indicating the determination result, for example.

### Operation Procedure of Management Device in Performing Anomaly Determination (Example 2)

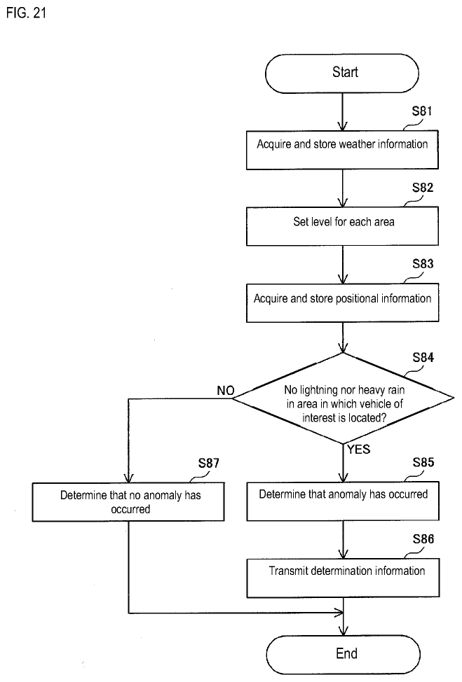

FIG. 21 is a flowchart defining an example of the operation procedure in which the management device according to the second embodiment of the present disclosure performs anomaly determination. FIG. 21 corresponds to “(Example 2)” above.

Referring to FIG. 21, first, the management device 201 acquires weather information transmitted from the weather information management device 202, and stores the acquired weather information (step S81). Next, the management device 201 sets a level for each area based on the newly received weather information and the stored map information (step S82). The management device 201 periodically or occasionally acquires and stores weather information and sets a level for each area (steps S81 and S82).

Next, the management device 201 acquires positional information transmitted from the switch device 101 of the vehicle 1, and stores the acquired positional information (step S83). Next, the management device 201 checks the vehicle 1 from which the positional information was transmitted, the vehicle 1 being a vehicle of interest, with respect to whether or not there is lightning and whether or not there is heavy rain in the area including the position of the vehicle 1 of interest. That is to say, the management device 201 checks the level of the area (step S84).

Next, if there is neither lightning nor heavy rain in the area, that is, if the level of the area is “2” or “3” (“NO” in step S84), the management device 201 determines that an anomaly has occurred in a transmission line in the vehicle 1 of interest (step S85), and transmits determination information indicating the determination result to the vehicle 1 of interest (step S86).

On the other hand, if there is at least one of lightning and heavy rain in the area including the position of the vehicle 1 of interest, that is, if the level of the area is “1” (“YES” in step S84), the management device 201 determines that no anomaly has occurred in the transmission lines in the vehicle 1 of interest (step S87). In this case, the management device 201 does not transmit determination information indicating the determination result, for example.

Note that the time when the management device 201 acquires and stores weather information and sets a level for each area (steps S81 and S82) is not limited to a time before it acquires positional information from the vehicle 1 and stores the positional information (step S83).

Some or all of the functions of the management device 201 according to the second embodiment of the present disclosure may be provided by cloud computing. That is to say, the management device 201 according to the second embodiment of the present disclosure may be constituted by a plurality of cloud servers or the like.

The other aspects of the configuration are the same as those in the first embodiment, and thus a detailed description thereof will not be repeated.

Incidentally, in the vehicle-mounted network described in JP 2013-168865A, data is transmitted and received between a plurality of vehicle-mounted devices. However, if an anomaly occurs in a transmission line of data between the vehicle-mounted devices, communication between these vehicle-mounted devices is not performed properly, which may cause issues such as the inability to control the vehicle properly.

On the other hand, the switch device 101, the management device 201, and the anomaly determination method according to the first and second embodiments of the present disclosure make it possible to detect a failure in a vehicle 1 in advance by use of the configuration and method described above.

The above embodiments should be considered in all respects illustrative and not restrictive. The scope of the disclosure is indicated by the claims not by the above description, and all changes that come within the meaning and range of equivalency of the claims are intended to be encompassed therein.

The description above encompasses the features described in Supplementary Notes below.

### Supplementary Note 1

A vehicle-mounted device that can be mounted in a vehicle, including: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit, wherein the vehicle-mounted device is a switch device that relays data between a plurality of other vehicle-mounted devices, and the determination unit performs the anomaly determination based on the propagation delay time measured by the measurement unit and an initial value of the propagation delay time.

### Supplementary Note 2

A vehicle-mounted device that can be mounted in a vehicle, including: a measurement unit configured to measure a propagation delay time of data between the vehicle-mounted device and another vehicle-mounted device mounted in the vehicle; and a determination unit configured to perform anomaly determination on a transmission line of the data, based on the propagation delay time measured by the measurement unit, wherein, in a case in which the determination unit determines in the anomaly determination that an anomaly has occurred, the determination unit transmits positional information indicating a current position of the vehicle, and at least one piece of vehicle information from among determination information indicating the determination result, vehicle type information indicating the type of the vehicle, state information indicating a state of the vehicle, time information indicating the current time, and delay time information indicating the propagation delay time, to a management device, the management device performs anomaly determination on a transmission line of data in the vehicle, based on the positional information and the one or plurality of pieces of vehicle information received from the vehicle, and other information, and, in a case in which it is determined that an anomaly has occurred, the management device transmits determination information indicating the determination result to the vehicle, and the vehicle-mounted device further includes a notification unit configured to perform an anomaly notification operation that makes a notification regarding the determination result indicated by the determination information transmitted from the management device.

### Supplementary Note 3

A management device including: an acquisition unit configured to acquire positional information regarding a vehicle of interest in which a propagation delay time of data between vehicle-mounted devices mounted in the vehicle of interest satisfies a predetermined condition; and a determination unit configured to perform anomaly determination on a transmission line of the data in the vehicle of interest, based on the positional information regarding the vehicle of interest acquired by the acquisition unit and other information, wherein the other information is at least one of map information, positional information regarding a vehicle other than the vehicle of interest, and weather information, and the determination unit determines whether a cause of the propagation delay time in the vehicle of interest satisfying the predetermined condition in the anomaly determination is in a transmission line in the vehicle of interest or in a driving environment of the vehicle of interest.

1. A vehicle-mounted device that can be mounted in a vehicle, comprising:
a measurement unit configured to measure a propagation delay time of data between the vehicle-mounted device and another vehicle-mounted device mounted in the vehicle; and
a determination unit configured to perform anomaly determination on a transmission line of the data, based on the propagation delay time measured by the measurement unit.

2. The vehicle-mounted device according to claim 1, wherein the determination unit performs the anomaly determination based on a history of the propagation delay time.

3. The vehicle-mounted device according to claim 1, wherein the determination unit performs the anomaly determination based on the propagation delay time and a threshold value, and changes the threshold value according to a state of the vehicle.

4. The vehicle-mounted device according to claim 1, wherein the measurement unit determines whether or not to perform processing for measuring the propagation delay time, based on a communication load on the transmission line of the data.

5. The vehicle-mounted device according to claim 1, further comprising a notification unit configured to perform an anomaly notification operation that makes a notification regarding a determination result from the determination unit,
wherein the notification unit changes the content of the anomaly notification operation according to the type of transmission line in which an anomaly has occurred.

6. A management device comprising:
an acquisition unit configured to acquire positional information regarding a vehicle of interest in which a propagation delay time of data between vehicle-mounted devices mounted in the vehicle of interest satisfies a predetermined condition; and
a determination unit configured to perform anomaly determination on a transmission line of the data in the vehicle of interest, based on the positional information regarding the vehicle of interest acquired by the acquisition unit and other information.

7. The management device according to claim 6, wherein the other information is positional information regarding another vehicle in which a propagation delay time of data between vehicle-mounted devices mounted in the other vehicle satisfies a predetermined condition.

8. An anomaly determination method for use by a vehicle-mounted device mounted in a vehicle, comprising:
a step of measuring a propagation delay time of data between the vehicle-mounted device and another vehicle-mounted device mounted in the vehicle; and
a step of performing anomaly determination on a transmission line of the data, based on the measured propagation delay time.

9. An anomaly determination method for use by a management device, comprising:
a step of acquiring positional information regarding a vehicle of interest in which a propagation delay time of data between vehicle-mounted devices mounted in the vehicle of interest satisfies a predetermined condition; and
a step of performing anomaly determination on a transmission line of the data in the vehicle of interest, based on the acquired positional information regarding the vehicle of interest and other information.

10. An anomaly determination program for use by a vehicle-mounted device mounted in a vehicle, for causing a computer to function as:
a measurement unit configured to measure a propagation delay time of data between the vehicle-mounted device and another vehicle-mounted device mounted in the vehicle; and
a determination unit configured to perform anomaly determination on a transmission line of the data, based on the propagation delay time measured by the measurement unit.

11. An anomaly determination program for use by a management device, for causing a computer to function as:
an acquisition unit configured to acquire positional information regarding a vehicle of interest in which a propagation delay time of data between vehicle-mounted devices mounted in the vehicle of interest satisfies a predetermined condition; and
a determination unit configured to perform anomaly determination on a transmission line of the data in the vehicle of interest, based on the positional information regarding the vehicle of interest acquired by the acquisition unit and other information.
